(19) United States
(12) Patent Application Publication
(10) Pub. No.: US 2010/0149825 A1
(43) Pub. Date: Jun. 17, 2010

(54) Escape Path Marking for an Aircraft

(75) Inventor: Wolfgang Sutter, Halstenbek (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: LUFTHANSA TECHNIK AG, Hamburg (DE)

(21) Appl. No.: 12/531,004

(22) PCT Filed: Mar. 11, 2008
(86) PCT No.: PCT/EP08/01928

§ 371 Date: Feb. 1, 2010

(30) Foreign Application Priority Data
Mar. 13, 2007 (DE) 07 005 098.4

(51) Int. Cl. F21S 8/10

(52) U.S. Cl. 362/470

(57) ABSTRACT

Escape path marking for aircraft, which has an afterglowing photoluminescing material which is placed in several elements on the floor, characterised in that at least one element has a bent shape.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The present invention relates to an escape path marking for an aircraft.

It is known to arrange photoluminescent strips on the floor of the aircraft for escape path marking in aircraft, which is also denoted as emergency marking. Photoluminescence is occasionally also denoted as afterglow and/or phosphorescence. The safety requirements are, for example, specified in the German Industry Standard DIN 67 510. The strips are laid in a straight line in the floor and direct the passengers and crew in the event of an emergency to the doors and emergency exits. In the past, photoluminescent strips have become increasingly accepted in the design of aircraft, as said strips are fail-safe and may be operated without a power supply.

An emergency lighting system is known, for example, from WO 96/33093 A1, in which a photoluminescent strip is arranged in a transparent carrier element. The carrier element may in this case be configured in one, two or three parts. Each carrier element has an elongate, rectangular shape and may accordingly be laid at a 90° and 180° orientation to a further carrier element.

A photoluminescent reflective sheet is known from WO 94/17766 A1. It is proposed to produce elongate strips from the two-dimensional material.

A photoluminescent escape path marking is known from U.S. Pat. No. 4,401,050 which consists of elongate strips. Arrows are provided as directional indicators for the marked escape path.

Directional indicators for the escape path are known from WO 87/02813 A1 which operate by photoluminescent means which are arranged along the aisle of the aircraft as separate disconnected arrows on the floor.

A durable fluorescing layer is known from EP 0 489 561 A1 in which colour pigments are incorporated in a polymer matrix. In this case, the fluorescent material may be incorporated in a carrier, which provides the fluorescent light with different optical properties by means of additional filters.

Safety signs backed with photoluminescing material are known from FR 2 308 155 A1.

U.S. Pat. No. 4,208,300 discloses an assembly for photoluminescing material as may be used on stairways and in road traffic situations.

It may be observed nowadays that requirements are changing for designing furniture for passenger cabins. In particular, there is a trend no longer to provide rectangular furniture but furniture with curved contours. In addition to the aesthetic effect of curved furniture, for example seat benches with a curved external contour, cupboards and counters in the service area, curved furniture also has safety advantages as the passengers, for example, may become injured less easily. Furniture of increasingly complicated design in the passenger cabin also makes it necessary to be able to adapt the escape path marking thereto in a flexible manner.

### BRIEF SUMMARY OF THE INVENTION

The object of the present invention is to provide an escape path marking which may be adapted by simple means to the most varied requirements and designs in the passenger cabin of an aircraft.

The escape path marking according to the invention is provided for an aircraft and has an afterglowing photoluminescing material. The photoluminescing material consists of a plurality of elements which are placed on the floor in order to show the passengers and crew the shortest path to an emergency exit in the event of an emergency. According to the invention, at least one of the laid elements has a bent shape. The element with the bent shape has a curved path, which makes it possible to lay the escape path not only in a straight line and/or at right angles but also to allow the escape path marking to extend in arcs and curves. As a result, the escape path marking may be individually adapted to the designs of the aircraft interior and thus follow predetermined contours. By means of the bent shape of the elements or by means of the bent elements, strip-shaped elements are denoted which do not extend in a straight line but describe an arc in the plane in which they are laid.

In a preferred embodiment, the photoluminescing material is provided on and/or in a transparent carrier material. The photoluminescing material may, for example, consist of photoluminescent pigments which are incorporated in a polymer matrix. Alternatively, the photoluminescent pigments may, for example, also be printed on a transparent carrier material.

In an expedient embodiment, in order to permit storage of the elements, the bent elements have a predefined radius of curvature. Moreover, it may be provided that at least two elements of different length are provided for each predefined radius of curvature. Elements with the same radius of curvature and of different length make it possible to combine said elements to form arcs with corresponding radii of curvature.

In an alternative embodiment, it is also possible to provide at least one bent element which has a non-uniform radius of curvature. Thus, for example, the bent element may have a plurality of portions, of which at least two respectively have a different radius of curvature. Bent elements with different radii of curvature may also be specifically adapted to the shape of furniture and built-in components in the aircraft interior, the radius of curvature thus also being able to be continuously altered.

In a preferred embodiment, the bent element is covered by a transparent material. The covering provides a protective cover which protects the photoluminescing material from damage.

Different embodiments are possible for covering the bent material. In a preferred embodiment, the bent element is cast into a transparent plastics material. In an alternative embodiment, the bent element is not completely enclosed by a transparent material but a bent covering element made of a transparent material is provided for receiving the bent element. The covering element corresponds, therefore, in its shape to the bent element made of photoluminescing material. In a preferred embodiment, the covering element is provided with a substantially U-shaped cross section, the limbs thereof being held to the side of or below the photoluminescing material. The limbs of the covering element are connected to the bent element and secure the covering element to the bent element.

For improved handling, it is preferably provided that the photoluminescing material is arranged on a U-shaped carrier element and the covering element is fastened to the carrier element.

In a further possible embodiment, the covering element is configured as a bent hollow profile. The bent element is then inserted into the bent hollow profile. The bent hollow profile may in cross section have a closed shape or, for example, have an interruption along its underside.

It is also possible to encase the bent element with a transparent heat-shrinkable tube which is shrunk onto the bent element. The heat-shrinkable tube is configured to be transparent on at least one side and thus allows the photoluminescing material to shine through. The heat-shrinkable tube preferably has a wall thickness of 0.1 to 0.8 mm, expediently in the range of 0.3 to 0.5 mm.

### BRIEF DESCRIPTION OF THE SEVERAL VIEWS OF THE DRAWINGS

Preferred embodiments are described in more detail hereinafter with reference to the figures, in which:

FIG. 1 shows in a schematic view the front region of an aircraft fuselage with the passenger cabin and cockpit,

FIG. 2 shows an escape path marking, in which the photoluminescing material is incorporated in a covering,

FIG. 3 shows a perspective view of the photoluminescent element of FIG. 2,

FIG. 4 shows a bent element with photoluminescing material in plan view,

FIG. 5 shows a perspective view of the element of FIG. 4,

FIG. 6 shows a cross section through the element with photoluminescing material of FIG. 4,

FIG. 7 shows a bent photoluminescent element which may be incorporated in a covering,

FIG. 8 shows three different embodiments for coverings of the photoluminescing material,

FIG. 9 shows a bent photoluminescing material with a heat-shrinkable tube in a view from above, and

FIG. 10 shows the bent element of FIG. 9 in a perspective view.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

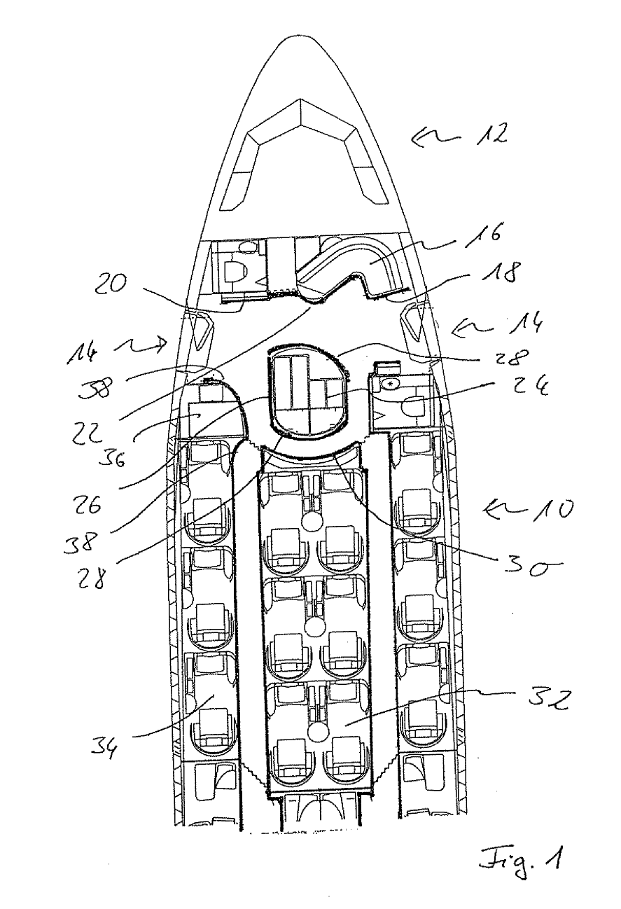

FIG. 1 shows a front portion of an aircraft with a passenger cabin 10 and a cockpit 12. In the front region of the passenger cabin 10, two doors 14 are provided to the side, which also serve for the emergency exit.

In the region between the passenger cabin 10 and the cockpit 12, a row of furniture and built-in components 16 is provided. The furniture and built-in components 16 are arranged in front of the exit doors 14. The front edge of the furniture and built-in components 16 is marked by an escape path marking 18. The escape path marking 18 has a row of straight portions 20 which alternate with bent portions 22.

The escape path marking 18 is made up of the elements described in more detail below which adjoin straight elements.

A central cupboard element 24 is also characterised by escape path markings extending in a curved manner. In the longitudinal direction of the aircraft, the escape path marking 26 has two straight portions 26 extending parallel to one another to which curved portions 28 adjoin on both sides. It is clearly visible that the portion 28 curved towards the front has a different curvature from the portion 28 curved towards the rear. It is also visible that the curved portion in the front region does not have a uniform radius of curvature but a variable radius of curvature which varies along the bent element.

The front end portion 30 of the central row 32 in the passenger cabin also has a curved escape path marking. Curved portions of the escape path marking may also be present on the side rows 34, for example at the transition between the seat row and a boundary element 36. In this connection, escape path markings 38, 40 which are curved in opposite directions may also be used in order to define the escape path accurately. Also indentations (not shown) may be provided between the seats.

FIG. 2 shows in a schematic view a bent element of an escape path marking. The element consists of photoluminescing material 40 which is incorporated in a covering element 42. In order to maintain the desired colour of the escape path marking, a further transparent colour filter film 44 may be arranged on the photoluminescent element 40.

FIG. 3 shows the element of FIG. 2 in a perspective view, in this case the filter film 44 additionally not yet being completely incorporated in the covering element 42. With a subsequent use of the carrier elements, an escape path is marked in substantially one colour, i.e. the photoluminescing material 40 is either used without an additional colour filter film 44 or all elements carry a colour filter film 44 with the desired colour.

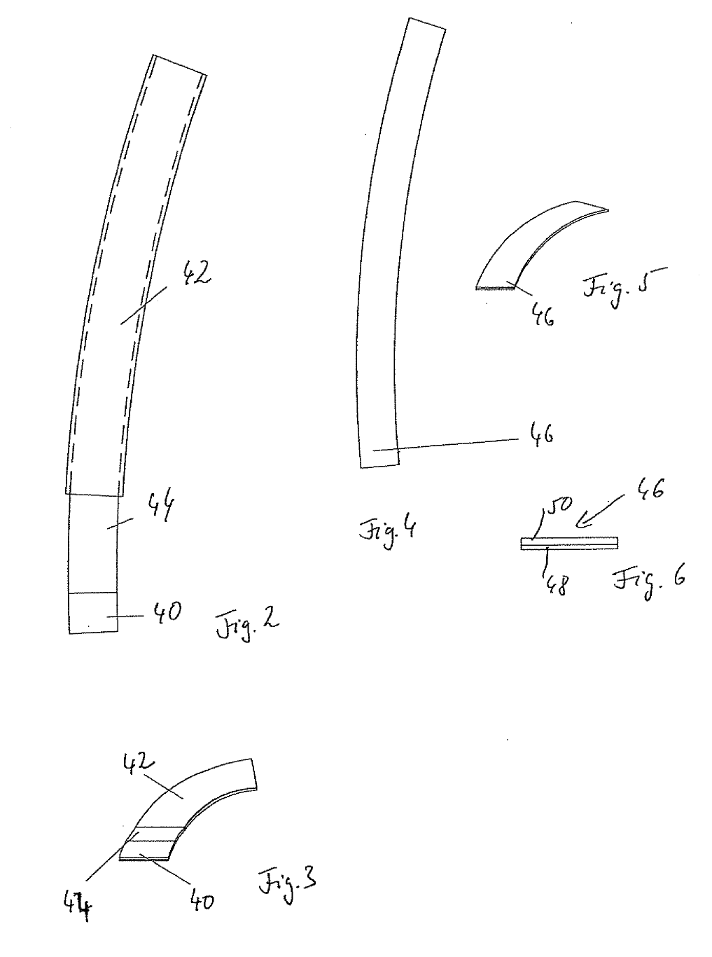

FIGS. 4 and 5 show a design for a bent element 46 in which a separate covering is not provided. The bent element 46 has, as shown in FIG. 6, a two-layered design. In this connection, for example, the lower layer 48 may be the photoluminescing material and the upper layer 50 may be a covering 50 made of a transparent material. Depending on the bonding agents used for the photoluminescing material, the layer 50 may also represent photoluminescing material incorporated in a plastics material, which is applied to a carrier element 48. The design of the two-layered bent element is particularly well-suited to planar floor coverings which adjoin the bent element. It is generally the case that the bent elements of the escape path marking should have the same height as the straight elements of the escape path marking.

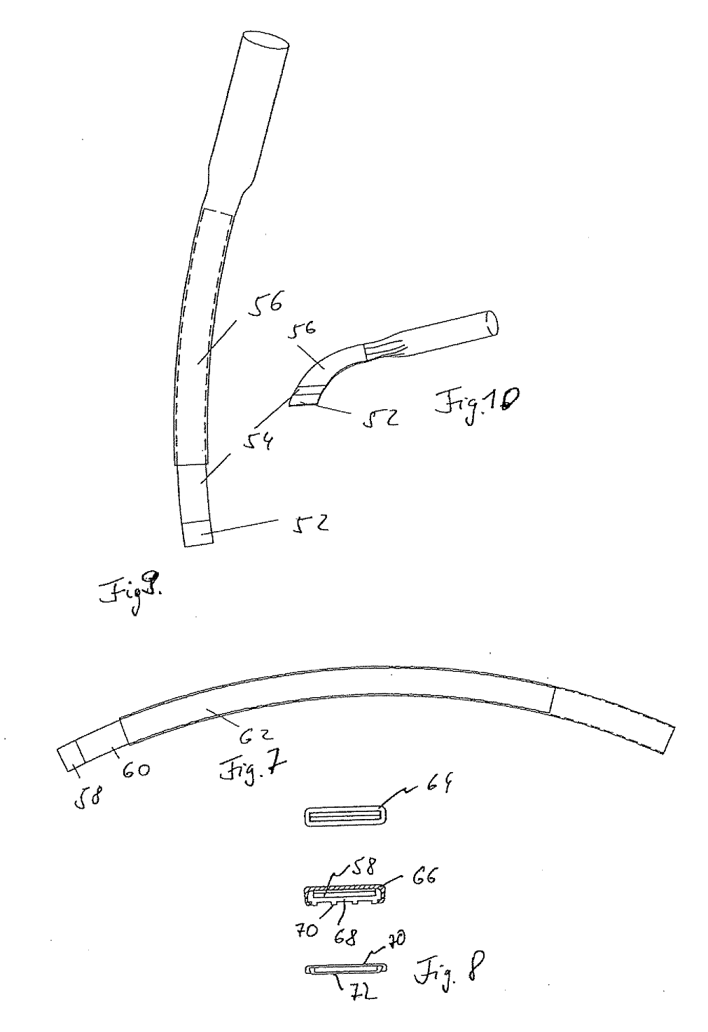

FIG. 7 shows a bent element 58 on which a colour filter film 60 is arranged. The bent element 58 and the colour filter film 60 are sealed by a covering 62. FIG. 8 shows a row of different embodiments for the covering. The covering 64 in FIG. 8 is a closed hollow profile made of transparent material, into which the bent element is incorporated. The covering 66 in FIG. 8 has a U-shaped profile, the side limbs engaging by a snap connection behind a projection on a carrier element 68. The carrier element 68 has a U-shaped profile with projections 70 extending in the longitudinal direction. The carrier element 68 receives the photoluminescent bent element 58; the photoluminescent element 58 is secured in the carrier element 68 via the covering 66. The covering 70 in FIG. 8 shows a further alternative embodiment in which the covering element is fastened by being clamped to the side of a carrier element 72. The carrier element 72 has a U-shaped profile, the carrier element 72 alternatively also being able to be provided with projections extending in the longitudinal direction.

The hollow profiles and snap profiles 62, 66 and 70 may be directly produced in a curved shape during extrusion, for example by deflecting the extruded section by means of rollers before the complete solidification of the extrudate (advantageously with uniform radii of curvature) or by subsequent heating and shaping of a straight extruded section. Alternatively, the profiles may also be cast, for example by injection moulding.

FIGS. 9 and 10 show an alternative encasing of a bent element 52 by a colour film 54. In order to enclose the bent element in a non-slip manner, a heat-shrinkable tube 56 is provided which is stretched over a colour filter film 54 and an element 52, and is shrunk-on in the extended position. The heat-shrinkable tube used for this purpose may have a thickness of 3/10 to 5/10 mm. The heat-shrinkable tube is shrunk onto the element by the action of heat and/or infrared radiation. The material of the heat-shrinkable tube is, therefore, not attached to the bent element. The heat-shrinkable tube is held exclusively by its membrane stress on the bent element.

The photoluminescing material is connected to the floor of the aircraft, irrespective of whether it is arranged in a carrier element or not. In this case, bonding is possible, smaller pieces not being bonded but preferably screwed to the subsurface. The production of elements in a curved shape may take place in different ways: on the one hand, the element may be produced as a coated semi-finished plate (for example by a colour coating method, calendering or casting) or, on the other hand, produced as a plate by extrusion and subsequently cut, stamped or sawn into the curved shape. Preferably, a water jet cutter is used for this purpose.

Alternatively, the luminous element may be directly produced in the bent shape. This may take place during extrusion, for example, by deflecting the extruded section by means of rollers before the complete solidification of the extrudate (advantageously with uniform radii of curvature). In the other methods, for example, the bent elements are produced by the colour coating of bent carrier strips or by casting into corresponding moulds. Luminous elements which are produced by thermoplastic material in a linear shape, for example by injection moulding or extrusion, may subsequently be heated and brought into the curved shape.

This completes the description of the preferred and alternate embodiments of the invention. Those skilled in the art may recognize other equivalents to the specific embodiment described herein which equivalents are intended to be encompassed by the claims attached hereto.

1. Escape path marking for aircraft, which has an afterglowing photoluminescing material which is placed in several elements on the floor, characterised in that at least one element (40; 46; 52; 58) has a bent shape.

2. Escape path marking according to claim 1, characterised in that the photoluminescing material is provided on and/or in a transparent carrier material.

3. Escape path marking according to claim 1, characterised in that each bent element has a predefined radius of curvature.

4. Escape path marking according to claim 3, characterised in that at least two elements of different lengths exist for each predefined radius of curvature.

5. Escape path marking according to claim 1, characterised in that at least one bent element (28) has a non-uniform radius of curvature.

6. Escape path marking according to claim 5, characterised in that the bent element has a plurality of portions, of which at least two have a different radius of curvature.

7. Escape path marking according to claim 1, characterised in that the bent element is covered by a transparent material.

8. Escape path marking according to claim 7, characterised in that the bent element is cast into a transparent material.

9. Escape path marking according to claim 1, characterised in that a bent covering element (42; 64; 66; 70) made of a transparent material is provided for the bent element.

10. Escape path marking according to claim 9, characterised in that the covering element (66; 70) has a substantially U-shaped cross section, the limbs being held to the side of or below the photoluminescing material.

11. Escape path marking according to claim 10, characterised in that the photoluminescing material is arranged on a U-shaped carrier element (68, 70).

12. Escape path marking according to claim 9, characterised in that the covering element is configured as a bent hollow profile (64).

13. Escape path marking according to claim 7, characterised in that the bent element is encased by a transparent heat-shrinkable tube (56) which is shrunk onto the bent element.

14. Escape path marking according to claim 13, characterised in that the heat-shrinkable tube has a wall thickness of 0.1 to 0.8 mm.
